(19) United States
(12) Patent Application Publication
(10) Pub. No.: US 2013/0041773 A1
(43) Pub. Date: Feb. 14, 2013

(54) Systems and methods to process online monetary payments dependent on conditional triggers involving future events

(71) Applicant: Randall Frank Muse, Poulsbo, WA (US)

(72) Inventor: Randall Frank Muse, Poulsbo, WA (US)

(21) Appl. No.: 13/572,636

(22) Filed: Aug. 11, 2012

Related U.S. Application Data
(60) Provisional application No. 61/522,807, filed on Aug. 12, 2011.

(51) Int. Cl. G06Q 30/08

(52) U.S. Cl. 705/26.3

(57) ABSTRACT

The present invention is a system to process online monetary payments between end-users whose payments are dependent on conditional triggers involving future events, such as winning bids/offers in an auction or a trading exchange. In the system, bids and offers are backed by actual funds which are held in reserve, enabling instantaneous payments upon the close of an event. The system contains methods to be included in online auction and trading exchange software applications. These methods would allow end-users of online auctions and trading exchanges to send and receive payments directly to one another.

### CROSS-REFERENCE TO RELATED APPLICATIONS

This application claims the benefit of U.S. provisional application No. 61/522,807 filed Aug. 12, 2011.

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM, LISTING COMPACT DISC APPENDIX

Not Applicable

### DESCRIPTION

### Technical Field

The invention has to do with electronic commerce, and in particular, the ways in which market participants send and receive payments using online payment processors. With regard to the invention, electronic commerce market participants will herein include banks, credit card firms, automated clearing houses, electronic currency transmitters, online payment processors, online auctions, online trading exchanges, online gaming websites, and end-user consumers.

### BACKGROUND

Network-based commerce systems have become prevalent in the online community, taking advantage of the Internet's worldwide connectivity in order to connect a large collection of market participants. Electronic commerce, or e-commerce, is conducted in the same fashion as regular commerce, except that buyers and sellers do not meet face to face. Therefore, the arranging for payment must be done online.

E-commerce is conducted via an online storefront at the merchant's website. Numerous versions of a storefront have come into use, with the majority being an extension of a brick and mortar business such as Sears.com, etc. Another type is it that seen with Amazon.com and Craigslist, which allows any seller to offer merchandise via the merchant's website for a fee.

Other types of storefronts have come into use in order to facilitate online auctions, trading exchanges, gaming websites, and peer-to-peer exchanges. With these types, the software application needed to run the storefront is usually complex.

Regardless of its type, all e-commerce has been made possible through the development of various online payment processing techniques. The first set of techniques was brought about by banks and automated clearing house organizations. This set includes payment by credit cards, debit cards, and electronic checks.

The second set of techniques includes two general methods of payment. The first method is payment via third party payment processors such as Paypal. A third party payment processor allows a buyer to purchase online without disclosing credit card or bank information.

The second method is payment via an electronic currency such as Ven, Bitcoin, or Liberty Reserve. Using e-currency is similar to using Paypal in that a consumer can purchase online without disclosing credit card and bank information. However, e-currency is just like a hard-backed currency, and can be floated on trading exchanges. E-currency is useful since it can be used by market participants from different countries without exchanging one hard-backed currency for another.

E-commerce has proved beneficial to the business world, by bringing together buyers and sellers could not meet otherwise. However, the way payments are handled in some online storefronts has proven to be problematic.

A payment problem is found with the online auction, for example. In this type of storefront, an item isn't simply bought or sold. The item has to be auctioned, and be won by a bidder. Only after the auction winner has been determined, can the process of arranging for payment begin. The winner has promised (by contract) to send payment at some future point, and with many auctions can wait as long as 14 days before sending. [1] Many times a winner neglects to complete the purchase at all, having found a cheaper price elsewhere. Studies show that the winning bidder fails to make a payment about 10-15% of the time on average, with sellers failing to report about 95% of the time. [2], [3]

Other problems have to do with online trading exchanges. There are three general types of trading exchanges: stock exchanges, foreign exchange, and sporting exchanges.

Foreign exchange, or forex, is different in that it is conducted in over-the-counter trading between two parties, usually a broker or dealer, rather than on a formal exchange. The advent of the Internet has given the opportunity for brokers and dealers to create online trading exchanges dealing in foreign exchange. These online foreign exchange websites have been become the default destination for the individual trader, who normally wants to buy and sell very in small increments. Another reason why the online exchange is useful is that a trader can lock in a price instantly, without having to telephone a broker for a quote.

A fundamental problem for traders who deal with forex trading exchanges is that they must pay fees to the broker or dealer for the opportunity to make a trade, though the broker/dealer is not providing access to any formal exchange. The broker/dealer bid or offer prices simply mirrors the current bid or offer at a major foreign exchange bank. Money is being exchanged by the broker and customer, but no amount of buying or selling by a customer will have any direct effect on the current bid/offer price.

This arrangement defeats the purpose of an exchange, as it is used with stock markets and commodity markets. These prices are only influenced by the dealings of large institutions and foreign exchange banks. So the forex broker/dealer is merely providing a website to make trades using prices that mirror a particular bank rate, and a place to send and receive money. Therefore, the payment problem for online forex traders is that they are essentially giving their money away in fees and not receiving much of anything in the way of service in return for the large fees they pay.

A payment problem can also be found with online sporting exchanges, where a trader can make bid/offer prices on the outcome of sporting events. These exchanges are similar to sports books or dealing with a bookie, except that users can become buyers or sellers, and bid or offer prices on events. This form of exchange is similar to a stock exchange because the bid/offer prices are affected by the dealings of trading exchange participants. It also resembles the forex market in that the market is not regulated by any one governing body, and therefore the operator of a trading exchange subscribes to a unique set of rules and fee structures, depending on what part of the world they are in.

A payment problem found with online sporting exchanges has to do with the fact that operating a sports trading exchange for profit is illegal in some areas, while legal in others. In the U.S., for example, it is further complicated since some online sporting exchanges are legal—horse betting exchanges in California and New Jersey for example—while other types of sports betting exchanges are illegal. So in some countries there are no legal business operators, resulting in confusion for consumers, who often must deal with foreign business operations who operate with limited or no regulation. Consumers must send their money away to a far away location and hope for the best.

Another payment problem with online sporting exchanges correlates directly with the above. Because consumers often must deal with foreign sporting exchange operators, the fees they must pay to send and receive money are more expensive than they would be dealing with a business in the same country. Fees charged for making bids and offers can be expensive, too. Some trading exchanges will accept business where operating a business is illegal, such as the U.S. These exchanges will accept U.S. consumers, and charge fees that are higher than can be found by consumers in other countries, who have their choice of many different exchanges.

A payment problem is found with online gaming websites as well. Online gaming, or skill gaming, has become prevalent in the online community. Users meet online at a gaming website and either play head-to-head with each other, or participate in a tournament. The largest of these gaming websites charge a fee to convert money into credits, sometimes as much as 30% in the case of Facebook. Paying such a fee simply for using a website is not in the best interest of the consumer.

### BRIEF SUMMARY OF THE INVENTION

The above described problems associated with online payments are all different, but have a similar thread running through them. That is, payment problems could be solved by methods that would allow payments to flow freely between buyer and seller, but also be flexible enough to allow for conditional events over time.

The first method would need to take place at the payment processor level using application software. The application would allow consumers to send and receive payments via available online payment processors on the market, but also allow payments to be made conditional on events, such as winning bids in auctions and trading exchanges. The application would allow each bid or offer to be backed by a real fund, held in reserve. In this way, a user's latest bid would represent an authorized fund, ready to be sent as a payment should the bid turn out to be the winner at the end of the event.

Other methods would take place at the website of the merchant and/or with the consumer's web browser via a stand-alone software application.

The payment problem with online auctions would be solved by allowing bids to be backed up with actual funds. This would require the auction software to infuse the bidding process with financial banking.

The payment problem with online trading exchanges and online gaming websites could be solved in much the same way as online auctions, by only allowing bids and offers to be backed up with actual funds. This would also require the trading software to infuse bidding with financial banking. By allowing bids and offers to be backed up with actual funds, a trading exchange could be operated without actually accepting deposits. Furthermore, trading exchanges and gaming websites could be operated with a very low fee structure. By using advertising to monetize the cost of the website, a trading exchange or gaming website could operate while charging zero fees.

Given the ability to operate an online trading exchange without charging fees or accepting deposits, operators would be free to conduct business in areas where doing so for profit is illegal. This would improve the situation for consumers by providing for safer, more cost effective trading.

### Current State of the Technology

The online payment processor, Paypal, features two innovative payment concepts with their Direct payment and Express Checkout. These programs allow merchants to authorize and capture payments directly from either the merchant website or the Paypal website. These programs simplify the process of using Paypal, but don't solve any of the above described problems. The online auction giant, E-bay, has also considered creating an automatic payment service to complement their regular auctions. [4] The idea E-bay is considering will make them a collector of funds and therefore, more of a traditional store than an auction service. The added accounting work necessary for this idea will no doubt eventually create higher fees or both buyer and seller.

E-bay also uses an innovative payment concept called buy-it-now. This allows an auction consumer to pay a stated price for an item, and purchase it immediately. This complements the auction process, but is not infused with it. Or, the buy-it-now feature resembles a regular online store purchase, rather than an online auction purchase.

Therefore, what is needed is a system and method(s) that would allow payments to flow freely between buyer and seller, but also be flexible enough to allow for conditional events over time. At the payment processor level, the system would allow consumers to send and receive payments that are conditional, based on events such as a winning bid in an auctions or trading exchange. At the client level, either a merchant website and/or a user's web browser, the system would allow each bid or offer to be backed by a real fund, held in reserve. In this way, a user's latest bid would represent an authorized fund, ready to be sent as a payment should the bid turn out to be the winner at the end of the event.

### SUMMARY OF EMBODIMENTS THE INVENTION

In one embodiment of the invention, a system and method(s) that would process online payments. The software application would allow consumers to send and receive payments via available online payment processors on the market, but also allow payments to be made conditional on events, such as winning bids in auctions and trading exchanges. The application would allow each bid or offer to be backed by a real fund, held in reserve. In this way, a user's latest bid would represent an authorized fund, ready to be sent as a payment should the bid turn out to be the winner at the end of the event.

In another embodiment of the invention, a system and method(s) interacts with traditional online payment processors, either as a plug-in software module or stand-alone software application. The application would allow consumers to send and receive payments via available bank person-to-person online payment processors on the market, but also allow payments to be made conditional on events, such as winning bids in auctions and trading exchanges. The application would allow each bid or offer to be backed by a real fund, held in reserve. In this way, a user's latest bid would represent an authorized fund, ready to be sent as a payment should the bid turn out to be the winner at the end of the event.

In another embodiment of the invention, a system and method(s) interacts with traditional online payment processors, either as a plug-in software module or stand-alone software application. The application would allow consumers to send and receive payments via available automated clearing house online payment processors on the market, but also allow payments to be made conditional on events, such as winning bids in auctions and trading exchanges. The application would allow each bid or offer to be backed by a real fund, held in reserve. In this way, a user's latest bid would represent an authorized fund, ready to be sent as a payment should the bid turn out to be the winner at the end of the event.

In another embodiment of the invention, a system and method(s) interacts with traditional online payment processors, either as a plug-in software module or stand-alone software application. The application would allow consumers to send and receive payments via available e-currency online payment processors on the market, but also allow payments to be made conditional on events, such as winning bids in auctions and trading exchanges. The application would allow each bid or offer to be backed by a real fund, held in reserve. In this way, a user's latest bid would represent an authorized fund, ready to be sent as a payment should the bid turn out to be the winner at the end of the event.

In another embodiment of the invention, a system and method(s) would be an online auction software application that infuses the bidding process with bank person-to-person online payment processors. The application would allow each bid or offer to be backed by a real fund, held in reserve. In this way, a user's latest bid would represent an authorized fund, ready to be sent as a payment should the bid turn out to be the winner at the end of the event.

In another embodiment of the invention, a system and method(s) would be an online auction software application that infuses the bidding process with automated clearing house online payment processors. The application would allow each bid or offer to be backed by a real fund, held in reserve. In this way, a user's latest bid would represent an authorized fund, ready to be sent as a payment should the bid turn out to be the winner at the end of the event.

In another embodiment of the invention, a system and method(s) would be an online auction software application that infuses the bidding process with e-currency online payment processors. The application would allow each bid or offer to be backed by a real fund, held in reserve. In this way, a user's latest bid would represent an authorized fund, ready to be sent as a payment should the bid turn out to be the winner at the end of the event.

In another embodiment of the invention, a system and method(s) interacts with traditional online auctions, either as a plug-in software module or stand-alone software application. The software would infuse the bidding process with bank person-to-person online payment processors, allowing each bid or offer to be backed by a real fund, held in reserve. In this way, a user's latest bid would represent an authorized fund, ready to be sent as a payment should the bid turn out to be the winner at the end of the event.

In another embodiment of the invention, a system and method(s) interacts with traditional online auctions, either as a plug-in software module or stand-alone software application. The software would infuse the bidding process with automated clearing house payment processors, allowing each bid or offer to be backed by a real fund, held in reserve. In this way, a user's latest bid would represent an authorized fund, ready to be sent as a payment should the bid turn out to be the winner at the end of the event.

In another embodiment of the invention, a system and method(s) interacts with traditional online auctions, either as a plug-in software module or stand-alone software application. The software would infuse the bidding process with e-currency online payment processors, allowing each bid or offer to be backed by a real fund, held in reserve. In this way, a user's latest bid would represent an authorized fund, ready to be sent as a payment should the bid turn out to be the winner at the end of the event.

In another embodiment of the invention, a system and method(s) would be an online foreign exchange trading software application which infuses the bidding process with bank person-to-person online payment processors. The application would allow each bid or offer to be backed by a real fund, held in reserve. In this way, a user's latest bid would represent an authorized fund, ready to be sent as a payment should the bid turn out to be the winner at the end of the event. By allowing bids and offers to be backed up with actual funds, a trading exchange could be operated without actually accepting deposits. Furthermore, trading exchanges and gaming websites could be operated with a very low fee structure. By using advertising to monetize the cost of the website, a trading exchange or gaming website could operate while charging zero fees.

In another embodiment of the invention, a system and method(s) would be an online foreign exchange trading software application which infuses the bidding process with automated clearing house online payment processors. The application would allow each bid or offer to be backed by a real fund, held in reserve. In this way, a user's latest bid would represent an authorized fund, ready to be sent as a payment should the bid turn out to be the winner at the end of the event. By allowing bids and offers to be backed up with actual funds, a trading exchange could be operated without actually accepting deposits. Furthermore, trading exchanges and gaming websites could be operated with a very low fee structure. By using advertising to monetize the cost of the website, a trading exchange or gaming website could operate while charging zero fees.

In another embodiment of the invention, a system and method(s) would be an online foreign exchange trading software application which infuses the bidding process with e-currency online payment processors. The application would allow each bid or offer to be backed by a real fund, held in reserve. In this way, a user's latest bid would represent an authorized fund, ready to be sent as a payment should the bid turn out to be the winner at the end of the event. By allowing bids and offers to be backed up with actual funds, a trading exchange could be operated without actually accepting deposits.

In another embodiment of the invention, a system and method(s) interacts with traditional online foreign trading exchanges, either as a plug-in software module or stand alone software application. The application would infuse the bidding process with bank person-to-person online payment processors, allowing each bid or offer to be backed by a real fund, held in reserve. In this way, a user's latest bid would represent an authorized fund, ready to be sent as a payment should the bid turn out to be the winner at the end of the event. By allowing bids and offers to be backed up with actual funds, a trading exchange could be operated without actually accepting deposits. Furthermore, trading exchanges and gaming websites could be operated with a very low fee structure. By using advertising to monetize the cost of the website, a trading exchange or gaming website could operate while charging zero fees.

In another embodiment of the invention, a system and method(s) interacts with traditional online foreign trading exchanges, either as a plug-in software module or stand-alone software application. The application would infuse the bidding process with automated clearing house online payment processors, allowing each bid or offer to be backed by a real fund, held in reserve. In this way, a user's latest bid would represent an authorized fund, ready to be sent as a payment should the bid turn out to be the winner at the end of the event. By allowing bids and offers to be backed up with actual funds, a trading exchange could be operated without actually accepting deposits. Furthermore, trading exchanges and gaming websites could be operated with a very low fee structure. By using advertising to monetize the cost of the website, a trading exchange or gaming website could operate while charging zero fees.

In another embodiment of the invention, a system and method(s) interacts with traditional online foreign trading exchanges, either as a plug-in software module or stand-alone software application. The application would infuse the bidding process with e-currency online payment processors, allowing each bid or offer to be backed by a real fund, held in reserve. In this way, a user's latest bid would represent an authorized fund, ready to be sent as a payment should the bid turn out to be the winner at the end of the event. By allowing bids and offers to be backed up with actual funds, a trading exchange could be operated without actually accepting deposits. Furthermore, trading exchanges and gaming websites could be operated with a very low fee structure. By using advertising to monetize the cost of the website, a trading exchange or gaming website could operate while charging zero fees.

In another embodiment of the invention, a system and method(s) would be an online sporting exchange software application which infuses the bidding process with bank person-to-person online payment processors. The application would allow each bid or offer to be backed by a real fund, held in reserve. In this way, a user's latest bid would represent an authorized fund, ready to be sent as a payment should the bid turn out to be the winner at the end of the event. By allowing bids and offers to be backed up with actual funds, a trading exchange could be operated without actually accepting deposits. Furthermore, trading exchanges and gaming websites could be operated with a very low fee structure. By using advertising to monetize the cost of the website, a trading exchange or gaming website could operate while charging zero fees.

In another embodiment of the invention, a system and method(s) would be an online sporting exchange software application which infuses the bidding process with automated clearing house online payment processors. The application would allow each bid or offer to be backed by a real fund, held in reserve. In this way, a user's latest bid would represent an authorized fund, ready to be sent as a payment should the bid turn out to be the winner at the end of the event. By allowing bids and offers to be backed up with actual funds, a trading exchange could be operated without actually accepting deposits. Furthermore, trading exchanges and gaming websites could be operated with a very low fee structure. By using advertising to monetize the cost of the website, a trading exchange or gaming website could operate while charging zero fees.

In another embodiment of the invention, a system and method(s) would be an online sporting exchange software application which infuses the bidding process with e-currency online payment processors. The application would allow each bid or offer to be backed by a real fund, held in reserve. In this way, a user's latest bid would represent an authorized fund, ready to be sent as a payment should the bid turn out to be the winner at the end of the event. By allowing bids and offers to be backed up with actual funds, a trading exchange could be operated without actually accepting deposits. Furthermore, trading exchanges and gaming websites could be operated with a very low fee structure. By using advertising to monetize the cost of the website, a trading exchange or gaming website could operate while charging zero fees.

In another embodiment of the invention, a system and method(s) interacts with traditional online sporting exchanges, either as a plug-in software module or stand-alone software application. The application would infuse the bidding process with bank person-to-person online payment processors, allowing each bid or offer to be backed by a real fund, held in reserve. In this way, a user's latest bid would represent an authorized fund, ready to be sent as a payment should the bid turn out to be the winner at the end of the event. By allowing bids and offers to be backed up with actual funds, a trading exchange could be operated without actually accepting deposits. Furthermore, trading exchanges and gaming websites could be operated with a very low fee structure. By using advertising to monetize the cost of the website, a trading exchange or gaming website could operate while charging zero fees.

In another embodiment of the invention, a system and method(s) interacts with traditional online sporting exchanges, either as a plug-in software module or stand-alone software application. The application would infuse the bidding process with automated clearing house online payment processors, allowing each bid or offer to be backed by a real fund, held in reserve. In this way, a user's latest bid would represent an authorized fund, ready to be sent as a payment should the bid turn out to be the winner at the end of the event. By allowing bids and offers to be backed up with actual funds, a trading exchange could be operated without actually accepting deposits. Furthermore, trading exchanges and gaming websites could be operated with a very low fee structure. By using advertising to monetize the cost of the website, a trading exchange or gaming website could operate while charging zero fees.

In another embodiment of the invention, a system and method(s) interacts with traditional online sporting exchanges, either as a plug-in software module or stand-alone software application. The application would infuse the bidding process with e-currency online payment processors, allowing each bid or offer to be backed by a real fund, held in reserve. In this way, a user's latest bid would represent an authorized fund, ready to be sent as a payment should the bid turn out to be the winner at the end of the event. By allowing bids and offers to be backed up with actual funds, a trading exchange could be operated without actually accepting deposits. Furthermore, trading exchanges and gaming websites could be operated with a very low fee structure. By using advertising to monetize the cost of the website, a trading exchange or gaming website could operate while charging zero fees.

### BRIEF DESCRIPTION OF THE DRAWINGS

FIG. 1A is a diagram depicting the relationships between the online auction, online payment network entity, and consumer(s), that otherwise make up one (online auction payments) environment for the invention.

FIG. 1B is a diagram depicting the relationships between the online auction, online payment network entity, and consumer(s), that otherwise make up one (online auction payments) environment for the invention, all work together.

FIG. 1C is a diagram depicting the relationships between the online trading exchange, independent data sources, online payment network entity, and consumer(s), that otherwise make up one (online trading exchange payments) environment for the invention.

FIG. 1D is a diagram depicting the relationships between the online trading exchange, independent data sources, online payment network entity, and consumer(s), that otherwise make up one (online trading exchange payments) environment for the invention, all work together.

FIG. 2A is a flow chart illustrating a system and methods that allows for a bid or offer in an online trading exchange to be backed by an actual fund in the amount of the bid or offer, with this fund to be held in reserve by an online payment network until the end of a time-based marketplace event. (e.g., binary trade, betting event)

FIG. 2B is a flow chart illustrating a system and methods that allows for a bid in an online auction be backed by an actual fund in the amount of the bid, with this fund to be held in reserve by an online payment network until the end of the auction.

FIG. 3A is a flow chart illustrating a method which gives an auction bid a unique auction bid code that is sent to an online payment network using encryption in the form of a digital certificate, and that uses this code to reserve funds in the amount of the bid.

FIG. 3B is a flow chart illustrating a method which gives a trading exchange bid or offer a unique code that is sent to an online payment network using encryption in the form of a digital certificate, and that uses this code to reserve funds in the amount of the bid or offer.

FIG. 4 is a flow chart illustrating a method which recognizes when an auction bid is not the first for the user in the auction, and which gives an auction bid a unique code that is sent to the online payment network encrypted with a digital certificate, canceling the earlier fund reserve, and replacing it with a new fund reserve.

FIG. 5A is a flow chart illustrating a method that, once a winning bidder is determined by the online auction, sends a transaction code and the user's online payment network ID to the online payment network, encrypted with a digital certificate, causing the winning bidder's reserved fund to be credited to the seller's account with the online payment network, and also causing all other reserved funds from other bidders in the auction to be cancelled, and credited back to their respective accounts.

FIG. 5B is a flow chart illustrating a method that, once a winner is determined by the online trading exchange, sends an auction code to the online payment network, encrypted with a digital certificate, causing a losing trade's reserved funds to be credited to the winning trader's account with the online payment network.

### DETAILED DESCRIPTION

This description is described to enable any person skilled in the art to make and use the invention, and is shown here with the knowledge that various changes to the disclosed embodiments will be apparent to those skilled in the art, and that these changes would not supersede the scope of the invention as depicted herein. Thus, the invention is not intended to be limited to the embodiments shown, but is to be given the widest scope parallel to the systems and methods illustrated herein.

It should be understood that the invention could be utilized within various versions of what is considered a computer system. (e.g., Desktop, Laptop computer, Mobile phone, etc) Specifics of how these machines work (e.g., Display, calculation, memory) is not presented for the purpose of brevity and clarity.

### The E-Commerce System

For the following embodiments, the software application that controls the various processes are either contained within the payment processor API program itself, or in a stand-alone application that interacts with a bank person-to-person API, automated clearing house API, e-currency payment processor API, or similar environment.

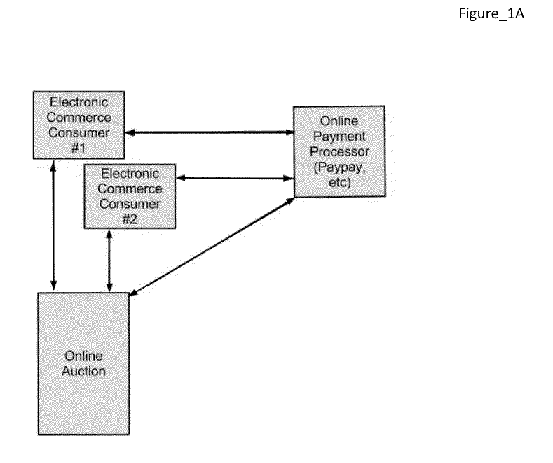

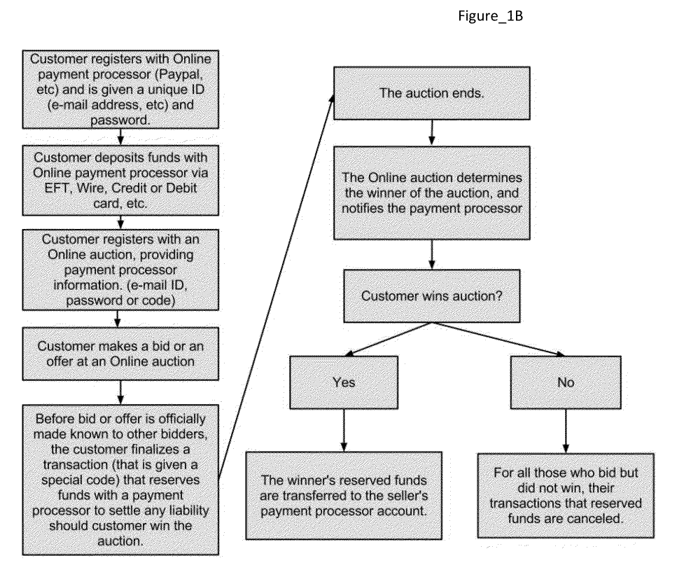

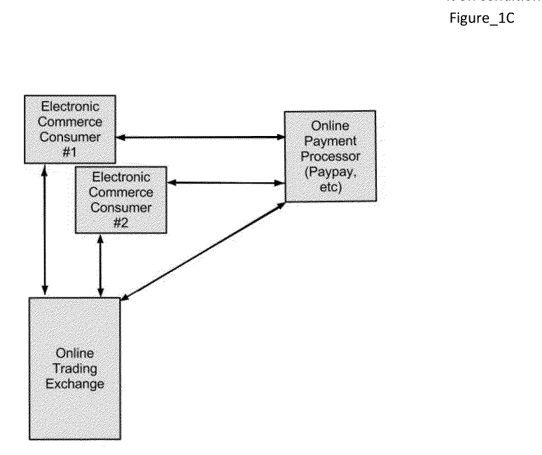

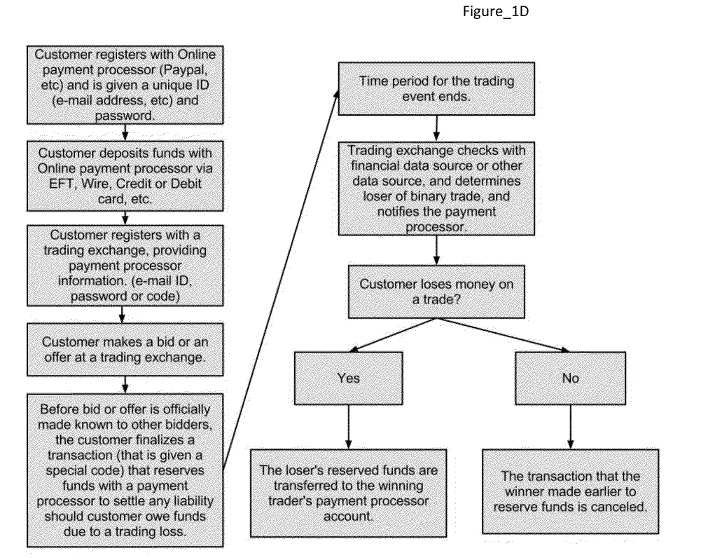

FIG. 1A is a diagram depicting the relationships between the online auction, online payment network entity, and consumer(s), that otherwise make up the relationship environment between entities for the invention.

In one embodiment, (FIG. 1B) the consumer accesses the online auction via the Internet and registers to be a user of the online auction. The consumer also accesses the online payment network via the Internet and registers to be a user with the system, and deposits funds to an account. The online auction accesses the services of the online payment processor using the online payment processor's API program procedures. These procedures allow users of the online auction to reserve funds to cover their last bid in an auction. Upon the end of an auction, an API program procedure cancels all reserved funds held for the accounts of those with non-winning bids, making those funds available to the user again. An API program procedure then takes the reserved funds of the winning bidder, and sends it as payment to the seller's account.

Using this system, sellers at the online auction receive payment directly upon the closing of an auction, greatly accelerating and streamlining the auction payment process. Instead of having to wait up to 14 days, payments are received instantly. The problem of a buyer neglecting to complete the purchase is solved as well.

FIG. 1C is a diagram depicting the relationships between the online trading exchange, independent data sources, online payment network entity, and consumer(s), that otherwise make up the relationship environment between entities for the invention.

In another embodiment, (FIG. 1D) the consumer accesses the online trading exchange via the Internet and registers to be a user of the auction system. The consumer also accesses the online payment network via the Internet and registers to be a user with the system, and deposits funds to an account. The online trading exchange accesses the services of the online payment processor using the online payment processor's API program procedures. These procedures allow users of the online trading exchange to reserve funds to cover their last bid in an auction. Upon the end of an auction, an API program procedure cancels all reserved funds held for the accounts of those with non-winning bids, making those funds available to the user again. An API program procedure then takes the reserved funds of the winning bidder, and sends it as payment to the seller's account.

When an online trading exchange is a sporting exchange, it is possible for a trading event to have multiple entrants, such as in horseracing, auto racing, or a golfing tournament. In these cases, a user can offer to sell multiple instances (entrants) of an event, and thus receive payments from buyers at the end of the event. For example, a seller could offer a price on 5 different cars in an auto race. If none of the 5 cars win the race, the seller would expect 5 different payments from 5 different buyers. In a scenario like this, an API program procedure takes the reserved funds from each buyer whose entrant does not win an event, and sends it as payment to the seller's account.

Using this system, online trading exchanges can operate without accepting deposits, and be located in areas where doing so is illegal. The system would greatly improve the situation for consumers as well, providing for safer, more cost effective trading.

The online Payment Network API

In one embodiment, an auction transaction code (State 2400) is generated after the auction closes and a winning bid is determined, and put into Table 70 of Database 170 via the online auction's back-end server. (Server 370) The transaction code and the users online payment network ID are then encrypted and sent to the online payment network by the API program, where it is put into Table 80 of Database 180 by the online payment network's back-end server. (Server 380) In State 2500, the winning bidder's reserved fund is credited to the seller's account. In State 2600, all reserved funds from losing bids associated with the auction are credited back to the user's account with the online payment network. The transaction bid code is then stored in Table 80 of Database 180 by the online payment network's back-end server. (Server 380)

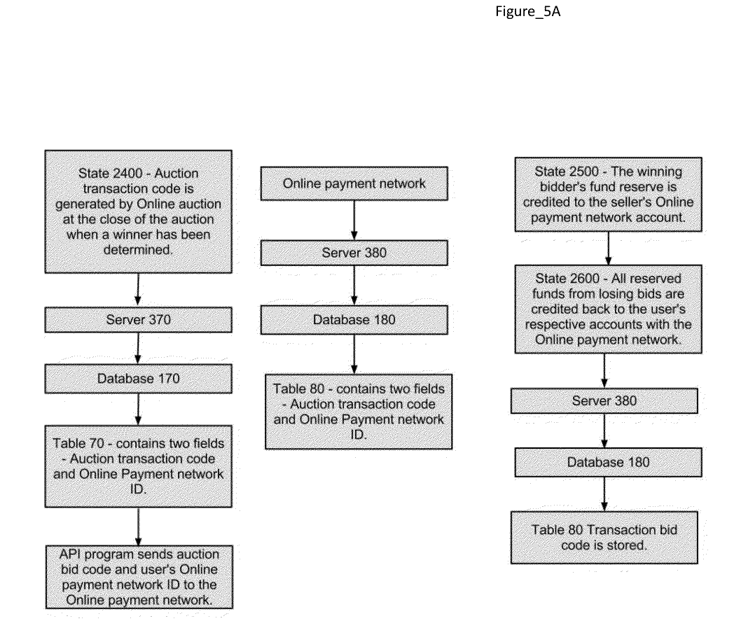

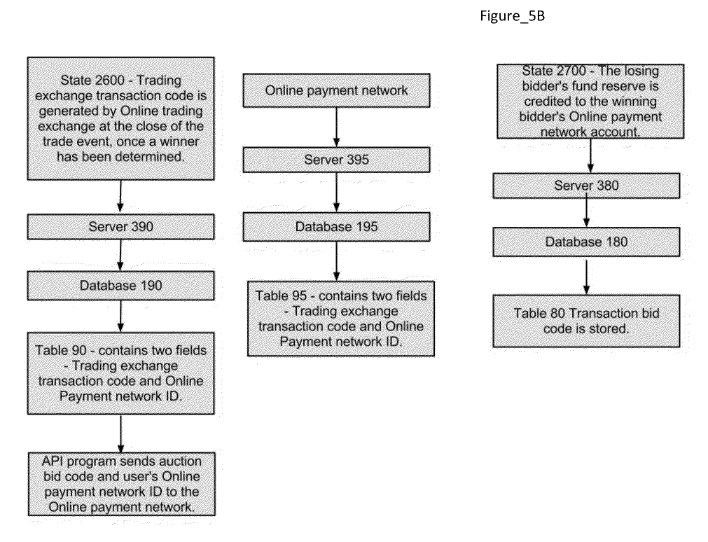

FIG. 5B is a flow chart illustrating a method that, once a winner is determined by the online trading exchange, sends an auction code to the online payment network, encrypted with a digital certificate, causing a losing trade's reserved funds to be credited to the winning trader's account with the online payment network.

In one embodiment, a trading exchange transaction code (State 2600) is generated after the trading event is over and the trading event winner is determined, and put into

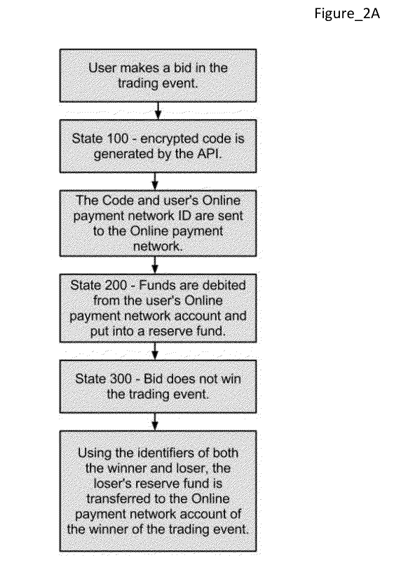

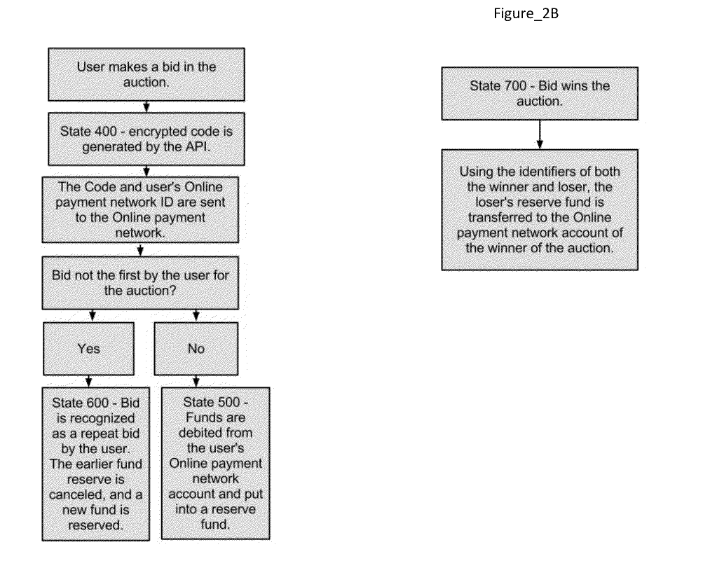

FIG. 2A is a flow chart illustrating a system and methods that allows for a bid or offer in an online trading exchange to be backed by an actual fund in the amount of the bid or offer, with this fund to be held in reserve by an online payment network until the end of a time-based marketplace event. (e.g., binary trade, betting event)

In one embodiment, the system itself is a computer program in the form of an API that allows the trading exchange user to access an online payment network via the online trading exchange website, thus allowing for reserve funds to be associated with bids and offers as they are made by the users of an online trading exchange.

The program uses digital certificates to authenticate a transaction each time the user makes a bid or offer, reserving funds in the user's account with an online payment network in the amount of the bid or offer. In State 100, the bid is given an encrypted code that, along with the user's online payment network ID, is sent to the online payment network. In State 200, a reserve fund is generated using the two identifiers. In State 300, the bid ends up losing, with the two identifiers used to generate a payment to the winner of the trade event.

FIG. 2B is a flow chart illustrating a system and methods that allows for a bid in an online auction to be backed by an actual fund in the amount of the bid, with this fund to be held in reserve by an online payment network until the end of the auction.

In another embodiment, the system itself is a computer program in the form of an API that allows the auction user to access an online payment network via the online auction website, thus allowing for reserve funds to be associated with bids as they are made by the users of an online auction.

The program uses digital certificates to authenticate a transaction each time the user makes a bid, reserving funds in the user's account with an online payment network in the amount of the bid. In State 400, the bid is given an encrypted code that, along with the user's online payment network ID, is sent to the online payment network. In State 500, a reserve fund is generated using the two identifiers. In State 600, the bid is identified as a repeat bid by the user, with the earlier reserved fund being replaced by a new reserved fund. In State 700, the auction closes and the bid ends up winning, with the two identifiers being used to generate a payment to the seller.

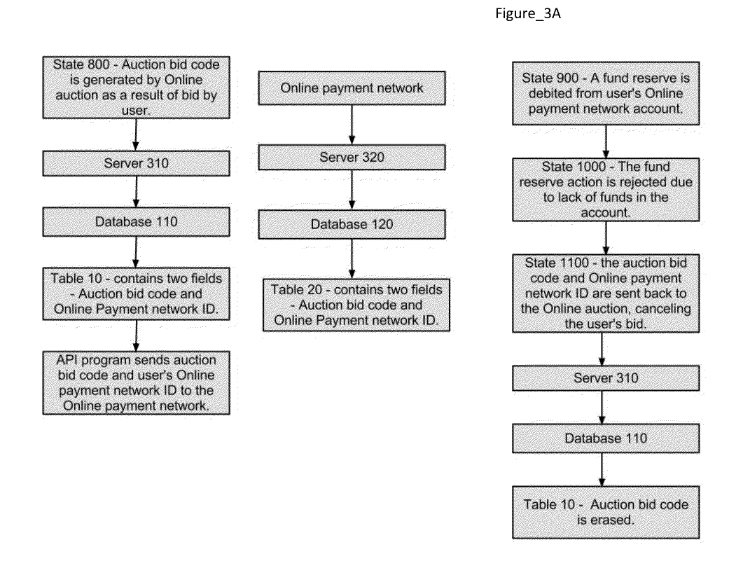

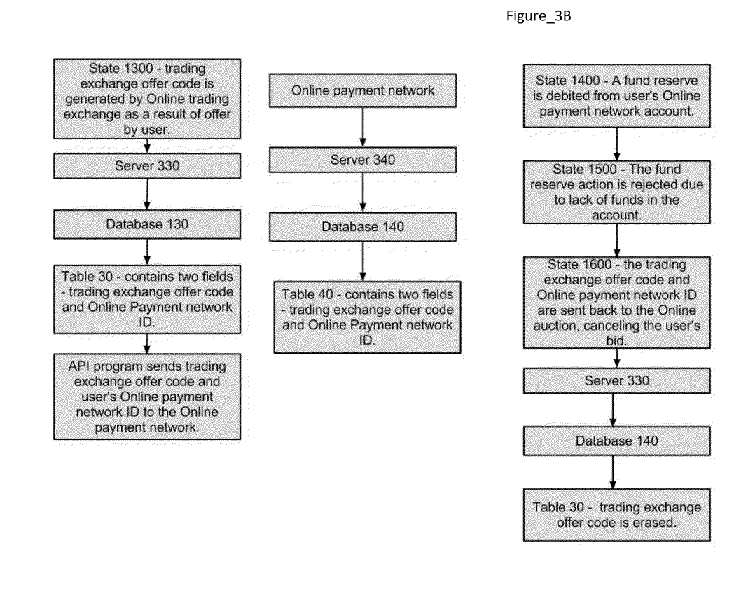

FIG. 3A is a flow chart illustrating a method which gives an auction bid a unique auction bid code that is sent to an online payment network using encryption in the form of a digital certificate, and that uses this code to reserve funds in the amount of the bid.

In one embodiment, an auction bid code (State 800) is generated as a result of an auction bid by a user, and put into Table 10 of Database 110 via the online auction's back-end server. (Server 310) The auction bid code and the user's online payment network ID are then encrypted and sent to the online payment network by the API program, where it is put into Table 20 of Database 120 by the online payment network's back-end server. (Server 320) In State 900, a fund is reserved using the auction bid code, with this amount being debited from the user's account. In State 1000, the reserving of funds is rejected due to lack of funds in the account. In State 1100, the auction bid code and online payment network ID are encrypted and sent back to the online auction. The online auction then cancels the user's bid. The bid is then erased from Table 10 of Database 110 by the online auction's back-end server. (Server 310)

FIG. 3B is a flow chart illustrating a method which gives a trading exchange bid or offer a unique code that is sent to an online payment network using encryption in the form of a digital certificate, and that uses this code to reserve funds in the amount of the bid or offer.

In another embodiment, a trading exchange offer code (State 1300) is generated as a result of a trading exchange offer by a user, and put into Table 30 of Database 130 via the online trading exchange's back-end server. (Server 330) The trading exchange offer code and the users online payment network ID are then encrypted and sent to the online payment network by the API program, where it is put into Table 40 of Database 140 by the online payment network's back-end server. (Server 340) In State 1400, a fund is reserved using the trading exchange offer code, with this amount being debited from the user's account. In State 1500, the reserving of funds is rejected due to lack of funds in the account. In State 1600, the trading exchange offer code and online payment network ID are encrypted and sent back to the online trading exchange. The online trading exchange then cancels the user's offer. The offer code is then erased from Table 30 of Database 130 by the online trading exchange's back-end server. (Server 330)

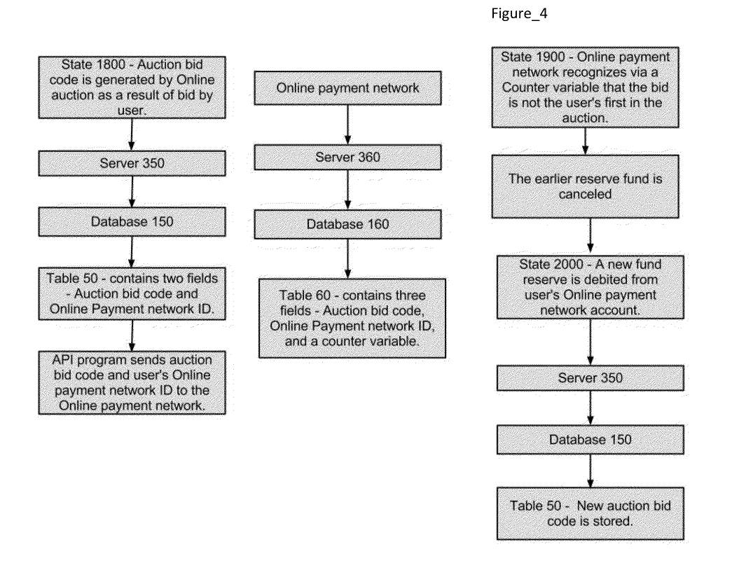

FIG. 4 is a flow chart illustrating a method which recognizes when an auction bid is not the first for the user in the auction, and which gives an auction bid a unique code that is sent to the online payment network encrypted with a digital certificate, canceling the earlier fund reserve, and replacing it with a new fund reserve.

In one embodiment, an auction bid code (State 1800) is generated as a result of an auction bid by a user, and put into Table 50 of Database 150 via the online auction's back-end server. (Server 350) The auction bid code and the user's online payment network ID are then encrypted and sent to the online payment network by the API program, where it is put into Table 60 of Database 160 by the online payment network's back-end server. (Server 360) In State 1900, the online payment network recognizes (Via an incremental counter variable) that the user already has a reserve for the particular auction, and cancels the earlier reserve fund. In State 2000, a fund is reserved using the auction bid code, with this amount being debited from the user's account. The auction bid code is then erased from Table 60 of Database 160 by the online payment network's back-end server. (Server 360)

FIG. 5A is a flow chart illustrating a method that, once a winning bidder is determined by the online auction, sends a transaction code and the user's online payment network ID to the online payment network, encrypted with a digital certificate, causing the winning bidder's reserved fund to be credited to the seller's account with the online payment network, and also causing all other reserved funds from other bidders in the auction to be cancelled, and credited back to their respective accounts. Table 90 of Database 190 via the online auction's back-end server. (Server 390) The transaction code and the users online payment network ID are then encrypted and sent to the online payment network by the API program, where it is put into Table 95 of Database 195 by the online payment network's back-end server. (Server 395) In State 2700, the losing trader's reserved fund is credited to the winning trader's account. The transaction bid code is then stored in Table 95 of Database 195 by the online payment network's back-end server. (Server 395)

For all embodiments involving the online auction, a method is used where the online payment network API establishes whether shipping is to be either pre-determined for all bids as to be one type to be decided by the user, or variable for each bid. For a variable shipping charge to be included with a bid, the online auction API will give the online Auction user a choice before the user confirms a bid. The shipping charge will then be added to the bid.

For all embodiments, a method is used where the online payment network uses a merchant code in order to identify what online auction or trading exchange is using the online payment network API.

### REFERENCES CITED

### Referenced By

### U.S. Patent Documents

U.S. Pat. No. 7,870,058
Maltzman Jan. 11, 2011
U.S. Pat. No. 8,108,278
Tzekin, et al. Jan. 31, 2012
U.S. Pat. No. 8,224,702
Mengerink, et al. Jul. 17, 2012
U.S. Pat. No. 8,229,855
Huang, et al. Jul. 24, 2012
U.S. Pat. No. 8,239,330
Montero, et al. Aug. 7, 2012

### OTHER REFERENCES

[1] “Online auctions: An in-depth look”. National Consumers League, date unknown, downloaded from http://www.nclnet.org/personal-finance/121-online-auctions/279-online-auctions-an-in-depth-look on Jun. 15, 2012.
[2] Ina Steiner. “Deadbeat Bidders Comprise 10% of eBay Unit Sales”. Ecommercebytes, Jan. 29, 2008, downloaded from http://www.ecommercebytes.com/cab/abn/y08/m01/i29/s02 on Jun. 10, 2012, 1 page.
[3] Bob Sullivan. “‘Deadbeat bidders’ dog eBay sellers—Auction winners who don't pay up are a growing trend”. MSNBC, Sep. 5, 2002, downloaded from http://www.msnbc.msn.com/id/3078738/ns/technology_and_science-tech_and_gadgets/t/deadbeat-bidders-dog-ebay-sellers/#.UCVN1qD61qB on Jun. 12, 2012.
[4] Ina Steiner. “eBay Mulls New Feature to Eliminate Deadbeat Bidders”. Ecommercebytes, May 12, 2012, downloaded from http://www.ecommercebytes.com/C/blog/blog.pl?/pl/2012/5/1336831866.html on Jun. 10, 2012, 1 page.

What is claimed is:

1. A system to process online monetary payments between end-users, which is comprised of software that which communicates between an end-user(s) and a transaction server; the communication being directly between an end-user and one or more other end-users; said payments of one or more end-users, to first consist of bids/offers in an auction or trading exchange; said bids or offers to be backed by actual funds, held in reserve; said bids/offers to involve conditional triggers on future events, such as winning bids/offers in an auction or a trading exchange; said bids/offers to be authorized as payment only upon finalization of an event, and determination of highest or winning bid/offer.

2. The system recited in claim 1, wherein the software interacts with person-to-person online payment processors, either as a plug-in software module or stand-alone software application.

3. The system recited in claim 1, wherein the software interacts with automated clearing house online payment processors, either as a plug-in software module or stand-alone software application.

4. The system recited in claim 1, wherein the software interacts with e-currency online payment processors, either as a plug-in software module or stand-alone software application.

5. A system, to be comprised of software, that which facilitates an online auction using a bidding process; said bidding process is linked with online payment processors, so that bids or offers are backed by actual funds, held in reserve; said bids/offers to be authorized as payment only upon finalization of an auction, and determination of highest or winning bid/offer.

6. The system recited in claim 5, wherein the software interacts with online auctions, either as a plug-in software module or stand-alone software application.

7. A system, to be comprised of software, that which facilitates an online foreign exchange trading station or sporting exchange using a bid/offer process; said bid/offer process is linked with online payment processors, so that bids/offers are backed by actual funds, held in reserve; said bids/offers to be authorized as payment only upon a bid price matching an offer price.

8. The system recited in claim 7, wherein the software interacts with online foreign exchange trading stations and sporting exchanges, either as a plug-in software module or stand-alone software application.
